(19) United States
(12) Patent Application Publication
(10) Pub. No.: US 2014/0313068 A1
(43) Pub. Date: Oct. 23, 2014

(54) APPARATUS AND A METHOD FOR OBTAINING INFORMATION ABOUT AT LEAST ONE TARGET

(71) Applicant: THE UNIVERSITY OF MELBOURNE, Melbourne (AU)

(72) Inventors: Robin John Evans, Aspendale (AU); John Zhong-Chen Li, Glen Waverley (AU); Efstratios Skafidas, Thornbury (AU); William Moran, University of Melbourne (AU); Mark Richard Morelande, University of Melbourne (AU)

(73) Assignee: THE UNIVERSITY OF MELBOURNE, Melbourne (AU)

(21) Appl. No.: 14/357,638

(22) PCT Filed: Nov. 9, 2012
(86) PCT No.: PCT/AU2012/001384

§ 371 Date: May 12, 2014

(30) Foreign Application Priority Data
Nov. 11, 2011 (AU) 2011904714

(51) Int. Cl. G01S 13/34

(52) U.S. Cl. CPC G01S 13/347
USPC 342/90

(57) ABSTRACT

A method of obtaining information about at least one target, includes transmitting a stepped frequency signal, obtaining a return radar signal corresponding to the transmitted stepped frequency signal from at least one target, bandpass filtering the return radar signal based on the frequencies of the transmitted frequency signal, converting the bandpass filtered return radar signal to a digital bandpass filtered return radar signal, and digitally mixing the digital bandpass filtered return radar signal with a digital mixing signal related to the stepped frequency signal to obtain information about the at least one target.

### FIELD

The invention relates to an apparatus and a method for obtaining information about at least one target.

### BACKGROUND

In one embodiment, the invention finds application in a low power chip-based radar.

Low power chip-based radars are becoming increasingly popular and widespread, especially in the automotive industry for safety and comfort applications such as collision avoidance or adaptive cruise control.

Due to the implementation technology of such radars, there are often severe power and complexity constraints placed on their design. Fulfilling the demand for wide fields of view and high angular resolution requires the use of multiple receiver channels and large signal distribution networks. Frequency-modulated waveforms are therefore commonly employed to allow for high transmit power with simple receiver architectures. Linear FM-CW in particular has emerged as a very popular waveform; providing simultaneous range and Doppler estimation by mixing the received signal with the transmitted signal to produce an intermediate beat frequency Δf which is proportional to range and Doppler shift.

$$Δ f = γ \frac{2 r}{c} + δ \qquad ( 1 )$$

where γ is the chirp rate, r and δ are the target range and Doppler respectively, and c is the speed of light.

An alternative frequency-modulated waveform is based on stepped frequency (SF) signals, where single pulses (tones) are transmitted in sequence to probe the scene at different frequencies and effectively build an image of the scene. Typical architectures for implementing such systems appear in FIG. 1. The modulating signal is up-converted to a RF signal centred at fc Hz for transmission and the received signal is either directly mixed with the up-converted signal (as shown in FIG. 1a), or down-converted to baseband and then further mixed with the transmitted tone (as shown in FIG. 1b), before being sampled and processed further digitally. Such architectures have the desirable property of allowing very low sampling rate analogue-to-digital converters (ADCs) as the beat frequency is usually in the order of megahertz for most applications.

Although simple in appearance, the realisation in integrating radar onto a single chip presents several challenges, especially when multi-channel receivers are required. In the architecture of FIG. 1a, the distribution of the frequency modulated RF signal to multiple receivers while maintaining coherence and sufficient transmit power is non-trivial.

While the architecture of FIG. 1b simplifies the design of the distribution network by breaking it into two stages, one distributing a fixed local oscillator (LO) signal and another distributing the baseband frequency modulated signal being tapped from the transmitter or generated independently via a DAC, it is at the cost of having two separate distribution networks and an extra mixer per receiver, increasing the on-chip size and reducing the number of receiver chains that can fit in a given area.

In the case of SF signals, both architectures are also affected by flicker noise as the frequencies of interest are ordinarily very close to DC. In the case of the architecture of FIG. 1b, this deficiency can be overcome by utilizing a low IF architecture to avoid DC and low frequency noise, at the cost of a second digital-to-analogue converter (DAC) to generate the secondary mixing signal.

Accordingly, there is a need for an alternative architecture.

### SUMMARY

In a first aspect, the invention provides a method of obtaining information about at least one target, comprising:
transmitting a stepped frequency signal;
obtaining a return radar signal corresponding to the transmitted stepped frequency signal from at least one target;
bandpass filtering the return radar signal based on the frequencies of the transmitted frequency signal;
converting the bandpass filtered return radar signal to a digital bandpass filtered return radar signal; and
digitally mixing the digital bandpass filtered return radar signal with a digital mixing signal related to the stepped frequency signal to obtain information about the at least one target.

In an embodiment:
transmitting the stepped frequency signal comprises upconverting a baseband stepped frequency signal; and
obtaining a return radar signal comprises downconverting a received signal.

In an embodiment, the digital mixing signal is related to the baseband stepped frequency signal.

In an embodiment, converting the bandpass filtered return radar signal to a digital bandpass filtered return radar signal comprises sampling at a sampling rate fₛ and the digital mixing signal is related to the digitally generated stepped frequency modulated signal by taking into account aliasing corresponding to fₛ.

In an embodiment, the method comprises performing the bandpass filtering with at least one adjustable frequency bandpass filter and adjusting the frequencies based on the frequency of the transmitted signal.

In an embodiment, the method comprises performing the bandpass filtering by switching between a plurality of fixed frequency bandpass filters

In an embodiment, the stepped frequency signal is a random step frequency signal.

In an embodiment, the stepped frequency signal is a linear step frequency signal.

In an embodiment, the method comprises generating a digital stepped frequency signal and converting the digital stepped frequency signal to the baseband stepped frequency signal and wherein the digital mixing signal is derived from the digital stepped frequency signal.

In a second aspect, the invention provides an apparatus for obtaining information about at least one target comprising:
a transmitter arranged to transmit a stepped frequency signal; a receiver arranged to obtain a return radar signal corresponding to the transmitted stepped frequency signal from at least one target, the receiver comprising at least one bandpass filter arranged to bandpass filter the return radar signal based on the frequencies of the transmitted stepped frequency signal, and an analogue to digital converter that converts the bandpass filtered return radar signal to a digital bandpass filtered return radar signal; and
a processor arranged to digitally mix the digital bandpass filtered return radar signal with a digital mixing signal related to the transmitted stepped frequency signal to obtain information about the at least one target.

In an embodiment, the transmitter upconverts a baseband stepped frequency signal; and
the receiver obtains the return radar signal by downconverting a received signal.

In an embodiment, the digital mixing signal is related to the baseband stepped frequency signal.

In an embodiment, the analogue to digital converter samples at a sampling rate fₛ and the digital mixing signal is related to the digitally generated stepped frequency modulated signal by taking into account aliasing corresponding to fₛ.

In an embodiment, the bandpass filter comprises at least one adjustable frequency bandpass filter and the bandpass filter is adjusted based on the frequencies of the transmitted signal.

In an embodiment, the apparatus comprises a plurality of adjustable frequency bandpass filters.

In an embodiment, the bandpass filter comprises of a bank of fixed frequency bandpass filters and a mechanism to switch between them.

In an embodiment, the stepped frequency signal is a random step frequency signal.

In an embodiment, the stepped frequency signal is a linear step frequency signal.

In an embodiment, the processor generates a digital stepped frequency signal and the transmitter comprises a digital to analogue converter to convert the digital stepped frequency signal to the baseband analogue stepped frequency signal, and wherein the digital mixing signal is derived from the digital stepped frequency signal.

### BRIEF DESCRIPTION OF DRAWINGS

An exemplary embodiment of the invention will now be described with reference to the accompanying drawings in which:

FIGS. 1a and 1b are block diagrams of prior art architectures;

FIG. 2 is a block diagram of an apparatus of an embodiment of the invention;

FIG. 3 shows transfer functions of a bank of bandpass filters;

FIG. 4 shows an example of a frequency sequence with 4 sub-bands;

FIG. 5 is a graph showing a comparison of target range estimates from conventional low pass and bandpass systems;

FIG. 6 shows a spectrum of a 106 MHz tone being sampled with a rate above Nyquist criterion.

FIG. 7 shows a spectrum corresponding to FIG. 6 after sub-sampling (bandpass sampling);

FIG. 8 shows the spectrum after digital down-conversion; and

FIG. 9 shows a baseband signal and a band-pass signal in the presence of flicker noise.

### DETAILED DESCRIPTION

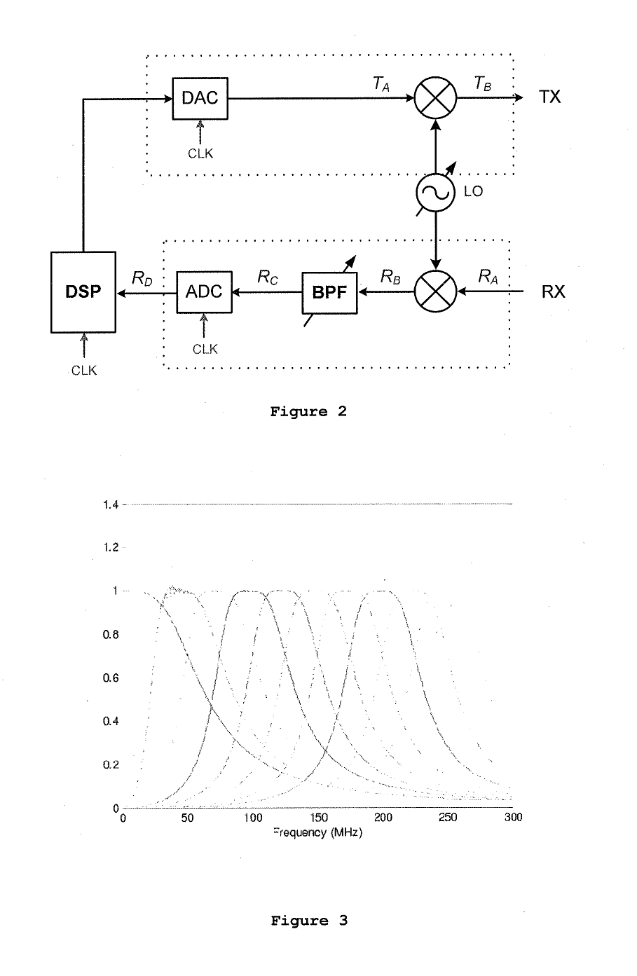

Referring to FIGS. 2 to 9, there is shown an apparatus that implements a radar architecture for stepped frequency waveforms using bandpass sampling techniques. The architecture is aimed at reducing hardware complexity and overcoming noise in short-range applications for stepped frequency waveforms. An application to a specific processing strategy is discussed, but the architecture is flexible and widely applicable.

For the purpose of explaining the embodiment, reference is made to stepped frequency modulated waveforms of the form described by Equation 2 operating in an imaging radar mode. The waveform consists of a series of M coherent pulses whose frequencies are varied from pulse to pulse. The frequency within each pulse remains constant. The duration of each pulse is r seconds. A burst of M pulses occupying a total bandwidth of B to realize a high resolution radar over a duration of T=Mτ; T is also called coherent processing interval (CPI).

$${x}_{p} ( t ) = \{ \begin{matrix}exp ( j2π {f}_{p} ( t ) t ) & t ∈ [ 0 , T ] \\ 0 & else\end{matrix} \\ x ( t ) = A {\sum }_{p = 0}^{M - 1} {x}_{p} ( t - pT ) \qquad ( 2 )$$

where A is the amplitude of the transmit signal and fₚ(t) is the frequency of each pulse.

Although the architecture is generally applicable, for clarity in presentation, only range estimation is described in detail.

A scene s(t) consists of K stationary point targets located at ranges rₖ, kε[1, K] for which estimates are to be obtained.

$$s ( t ) = {\sum }_{k = 1}^{K} αδ ( t - \frac{2 {r}_{k}}{c} ) \qquad ( 3 )$$

where

$$α = \frac{σ}{{r}_{k}^{4}}$$

captures the loss according to the radar equation and

$$\frac{2 {r}_{k}}{c}$$

is the to-and-back propagation time.

The received signal is given by

y(t)=(x*s)(t)+n(t) (4)

where

$$n ( t ) \sim N ( 0 , \frac{{N}_{0}}{2} )$$

is additive white Gaussian noise.

In one example embodiment, the return from each pulse is used to determine the complex Fourier transform of the scene at each frequency. The inverse Fourier Transform is used to obtain an estimate of the scene s(t).

For simplicity, assume the filtered return signal is sampled once per pulse at the end of the pulse period. An estimate of the scene is obtained once samples of all M pulses have been collected.

$${s}_{k} = y ( t - k τ ) \\ {\tilde{S}}^{n} = \frac{1}{N} {\sum }_{k = 1}^{Mn} {s}_{k} exp ( j2π \frac{kn}{M} ) \qquad ( 5 )$$

The nature of the waveform is such that, although it occupies bandwidth B over the duration of the entire waveform, each pulse is a continuous wave of frequency fₚ and duration r and thus has instantaneous bandwidth 1/τ.

By employing bandpass sampling, a rate of 2/τ Hz is sufficient to satisfy the Nyquist criterion for recovering the signal. Frequency folding occurs on sampling, but the nature of the signal means the folding is not ambiguous and the original signal can be recovered. After sampling, matched filtering is implemented digitally in the processor by mixing with an appropriately reconstructed tone (accounting for the new spectral location of the signal due to aliasing) to obtain magnitude and phase information. That is, the digital mixing signal corresponds to the original digitally generated digital stepped frequency signal adjusted due the aliasing of frequencies greater than the sampling rate of the analogue to digital converter during the sampling process.

For example, a pulse x(t) with baseband frequency in the form f₀,x(t)=exp(j2πf₀t) would be mixed with xₘ(t) in the form xₘ(t)=exp(2πfₘt). where fₘ=f₀ mod

$$\frac{{f}_{ADC}}{2}$$

is the aliased frequency of the original pulse.

A block diagram of the architecture appears in FIG. 2. In FIG. 2 a processor (DSP) generates a digital stepped frequency signal. Typically, the digital stepped frequency signal is a random step frequency signal to minimize interference, however in some embodiments a linear step frequency signal may be suitable.

The transmitter has a digital to analogue converter (DAC) that converts the digital stepped frequency signal to an analogue baseband stepped frequency signal T_{A} which is then up-converted by mixing it with a carrier f_{c} for transmission T_{B} in the desired RF band (e.g. at 77 Ghz). In the receiver, the received signal R_{A} is mixed with the carrier to obtain a baseband return radar signal R_{B}. This is then filtered by the tuneable bandpass filter (BPF) of the receiver. The bandpass filtered return radar signal R_{C} is then sampled by an analogue to digital converter (ADC) of the receiver to obtain a digital bandpass filtered return radar signal R_{D} which is then mixed with the mixing signal by the processor (DSP) in order to obtain information about the target as described above.

While generating the stepped frequency signal digitally before converting it to analogue allows for convenient reconstruction of a digital mixing signal derived from the originally generated step frequency signal, the stepped frequency signal can be generated in other ways. For example, by using a tuning voltage controlled oscillator. In such an example, the digital mixing signal can be obtained by sampling. For example, by sampling the analogue baseband signal before upconversion.

A potential problem with bandpass filtering is increased noise bandwidth at the input to the ADC, reducing the SNR after sampling. As a reference, consider the signal-to-noise ratio (SNR) of the low-pass sampling architecture. The receiver has bandwidth B and thus the SNR after sampling is proportional to

$$\frac{{A}^{2}}{{BN}_{o}} .$$

Simply reducing the sampling rate raises the noise floor of the sampled signal as the wideband noise is folded in to the bandwidth of the ADC. Let the reduction in sampling rate be given by

$$λ = \frac{B}{{f}_{ADC}} \qquad ( 6 )$$

where f_{ADC} is the bandpass sampling rate, in the above example given by 1/τ. The SNR of the bandpass sampling system is then

$$\frac{{A}^{2}}{λ {BN}_{0}} .$$

To preserve the SNR, one embodiment employs a tuneable bandpass filter with bandwidth f_{ADC}. However, this may present challenges in the hardware design, as the required tuning range of the filter may be difficult to achieve with low distortion. Accordingly in another embodiment, in order to reduce the required tuning range, RF band sub-division may be employed. In another embodiment, a plurality of tuneable bandpass filters may be employed.

Accordingly, a number of features of embodiments of the invention contribute to an improvement in SNR after sampling, specifically:
Increasing the sampling rate of the ADC.
Dividing the RF band into channels and low-pass filtering the output of the down-conversion mixer.
Filtering the input to the ADC with a tuneable band-pass filter.

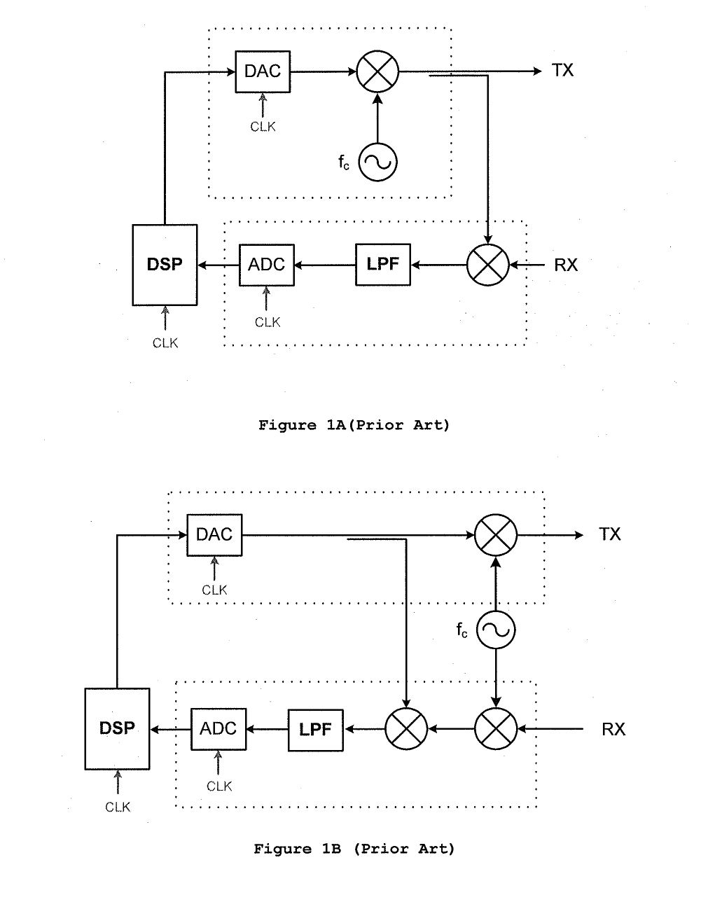

By combining these techniques, the SNR degradation of the band-pass sampling architecture can be made to be insignificant compared to the conventional architectures in FIG. 1.

While it is desirable to keep the sampling rate of the ADC as low as possible, increasing the speed of the ADC relaxes the bandwidth of the filter and thus decreases the Q factor leading to easier hardware design.

A tuneable band-pass filter (BPF) is used to select the portion of the band which the return signal occupies and remove noise from frequency bands which will be aliased into the band of interest. To achieve this, the filter bandwidth is set to be less than half the sampling rate of the ADC so that it acts as an anti-aliasing filter.

The centre frequency of the tuneable filter is known from the transmitted waveform. Constraints on the speed of switching the centre frequency and the available tuning range limit the frequency sequence that may be used. Ideally, the filter centre frequency should be switchable for every pulse in the sequence of the signal T_{A}. If the filter does not respond sufficiently fast for this, the sequence is limited to using tones in each filter band in some sequence before jumping to other bands, potentially placing some constraints on the degree of randomness of the stepped frequency signal that can be employed, where it is generally desirable for the stepped frequency to be as random as possible.

By allowing a tuneable carrier frequency f_{c}, the available RF bandwidth can be divided into smaller sub-bands to reduce the required tuning range of the band-pass filter.

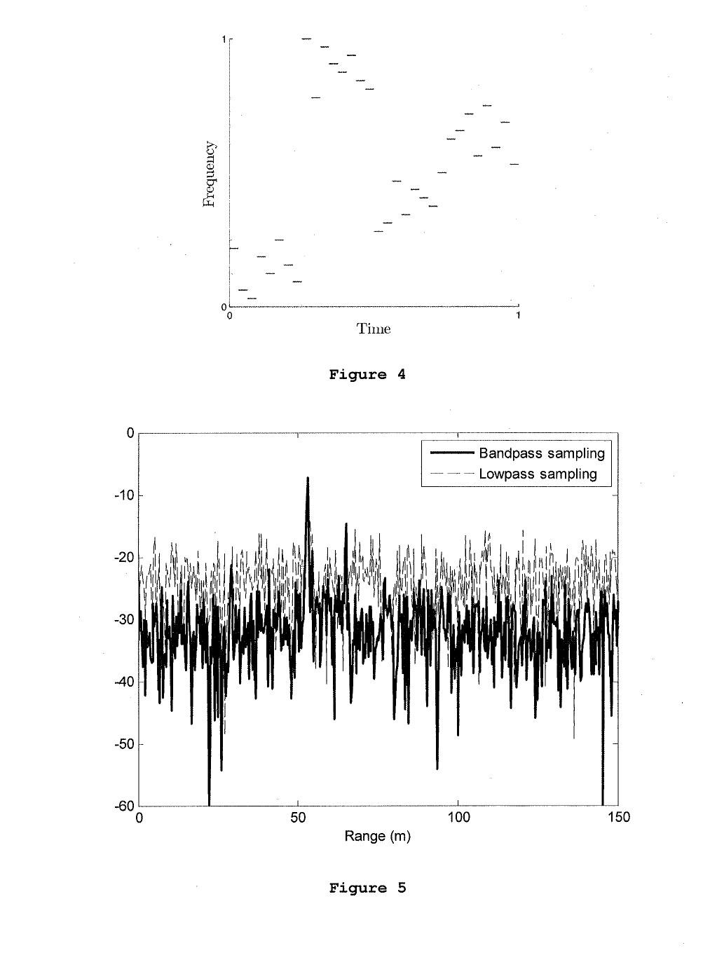

An alternative solution is to employ a bank of filters, each tuneable in a specific range corresponding to a sub-band, and to switch between these in order to simulate the effect of carrier band sub-division. Limitations in the switching speed between carrier channels in this architecture does impose some loss of freedom in the allowable frequency sequences by requiring tones in each sub-band to be transmitted together before moving on to the next. However, tones in each block may still be freely ordered, as can the sequence of sub-bands. An example sequence appears in FIG. 4. A still further solution is to employ a bank of fixed frequency bandpass filters and a switching mechanism for switching between them.

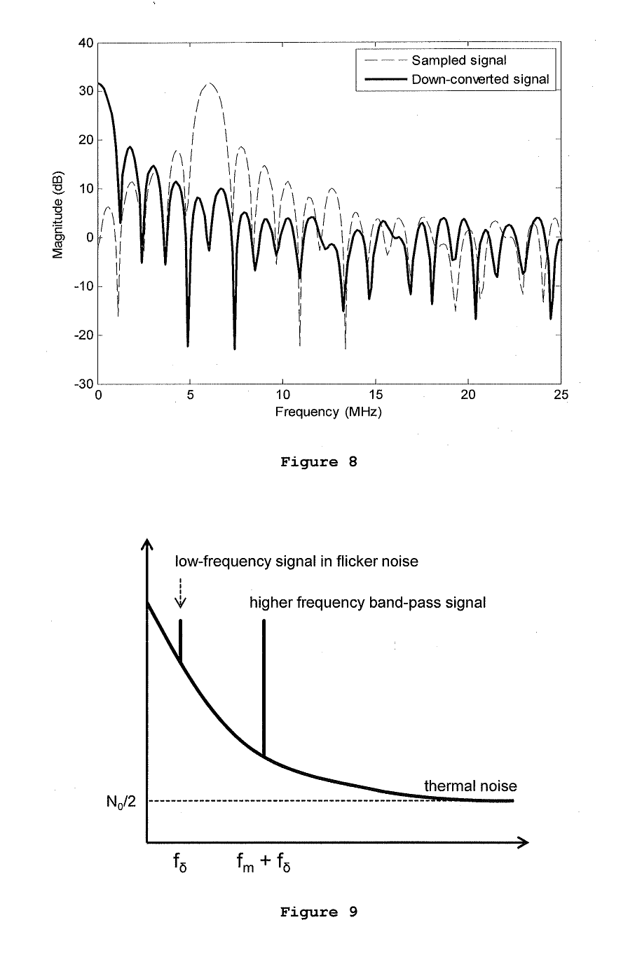

It is noted that the embodiment also has some advantages with respect to noise in the RF electronics design. In the architecture described in FIG. 1, the mixed signal being sampled is usually very close to DC, with only a small offset due to the Doppler shift on the order of kilohertz in typical scenarios. As such it is very susceptible to 1/f flicker noise. In the bandpass architecture of FIG. 2, the received signal is not mixed with the transmitted tone and the sampled signal remains at some higher frequency, avoiding the flicker noise as shown in FIG. 9.

Further, a reduction in ADC sampling rate lowers the data storage and processing requirements of the digital signal processor (DSP) and allows for faster updates in on-line processing. The reduced data rate allows for a simpler DSP front-end which can be more readily obtained from commodity parts and does not require specialised high-speed design.

### Example

The performance of the proposed architecture under various design choices were explored with a numerical simulation and compared to that of a conventional low-pass system. In this example the system has nominal parameters as follows:

| | |
|---|---|
| Total bandwidth | B = 1 GHz |
| No. of tones | M = 1000 |
| Tone period | τ_{chip} = 1 μs |
| Carrier frequency | f_{c} = 76.5 GHz |
| No. of RF sub-bands | 4 |
| ADC sampling rate | f_{ADC} = 50 MHz |

The scene consists of two point targets located at ranges of 50 m and 75 m. The scene estimate from both a low-pass and bandpass system appear in FIG. 5. From FIG. 5 it is evident that with appropriate filtering the bandpass sampling system is able to recover the scene estimate with no degradation from the low-pass equivalent and a significantly slower sampling ADC.

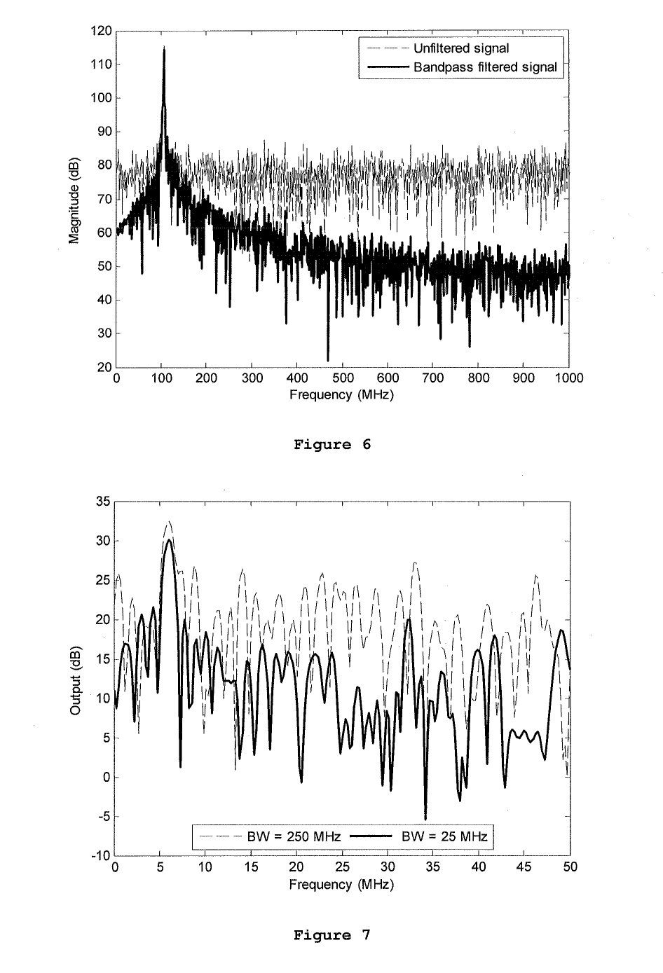

To further examine the effect on performance, spectra at various points in the receiver chain with various mixing configurations were plotted. FIG. 6 and FIG. 7 show the spectrum at baseband before and after sampling both with and without an appropriate bandpass filter. It is evident that without appropriate filtering the aliased noise easily overwhelms the return signal. However, with appropriate filtering, the desired signal can be recovered.

The spectrum after digital down-conversion by the ADC is shown in FIG. 8 for various filter bandwidths. Again, the effect of aliased noise is clearly visible when the filter for the conventional low-pass filtering design (250 MHz) is used instead of the appropriate bandpass 25 MHz filter.

In the above description certain steps are described as being carried out by a processor, it will be appreciated that such steps will often require a number of sub-steps to be carried out for the steps to be implemented electronically, for example due to hardware or programming limitations.

Herein the term “processor” is used to refer generically to any device that can generate and process digital signals. However, typical embodiments will use a digital signal processor optimised for the needs of digital signal processing.

It will be understood to persons skilled in the art of the invention that many modifications may be made without departing from the spirit and scope of the invention, in particular it will be apparent that certain features of embodiments of the invention can be employed to form further embodiments.

It is to be understood that, if any prior art is referred to herein, such reference does not constitute an admission that the prior art forms a part of the common general knowledge in the art in any country.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1. A method of obtaining information about at least one target, comprising:
transmitting a stepped frequency signal;
obtaining a return radar signal corresponding to the transmitted stepped frequency signal from at least one target;
bandpass filtering the return radar signal based on the frequencies of the transmitted frequency signal;
converting the bandpass filtered return radar signal to a digital bandpass filtered return radar signal; and
digitally mixing the digital bandpass filtered return radar signal with a digital mixing signal related to the stepped frequency signal to obtain information about the at least one target.

2. A method as claimed in claim 1, wherein:
transmitting the stepped frequency signal comprises upconverting a baseband stepped frequency signal; and
obtaining a return radar signal comprises downconverting a received signal.

3. A method as claimed in claim 2, wherein the digital mixing signal is related to the baseband stepped frequency signal.

4. A method as claimed in claim 1, wherein converting the bandpass filtered return radar signal to a digital bandpass filtered return radar signal comprises sampling at a sampling rate fₛ and the digital mixing signal is related to the digitally generated stepped frequency modulated signal by taking into account aliasing corresponding to fₛ.

5. A method as claimed in claim 1, comprising performing the bandpass filtering with at least one adjustable frequency bandpass filter and adjusting the frequencies based on the frequency of the transmitted signal.

6. A method as claimed in claim 1 comprising performing the bandpass filtering by switching between a plurality of fixed frequency bandpass filters.

7. A method as claimed in claim 1 wherein the stepped frequency signal is a random step frequency signal.

8. A method as claimed in claim 1 wherein the stepped frequency signal is a linear step frequency signal.

9. A method as claimed in claim 2, comprising generating a digital stepped frequency signal and converting the digital stepped frequency signal to the baseband stepped frequency signal and wherein the digital mixing signal is derived from the digital stepped frequency signal.

10. An apparatus for obtaining information about at least one target comprising:
a transmitter arranged to transmit a stepped frequency signal;
a receiver arranged to obtain a return radar signal corresponding to the transmitted stepped frequency signal from at least one target, the receiver comprising at least one bandpass filter arranged to bandpass filter the return radar signal based on the frequencies of the transmitted stepped frequency signal, and an analogue to digital converter that converts the bandpass filtered return radar signal to a digital bandpass filtered return radar signal; and
a processor arranged to digitally mix the digital bandpass filtered return radar signal with a digital mixing signal related to the transmitted stepped frequency signal to obtain information about the at least one target.

11. An apparatus as claimed in claim 10, wherein:
the transmitter upconverts a baseband stepped frequency signal; and
the receiver obtains the return radar signal by downconverting a received signal.

12. An apparatus as claimed in claim 11, wherein the digital mixing signal is related to the baseband stepped frequency signal.

13. An apparatus as claimed in claim 10, wherein the analogue to digital converter samples at a sampling rate fₛ and the digital mixing signal is related to the digitally generated stepped frequency modulated signal by taking into account aliasing corresponding to fₛ.

14. An apparatus as claimed in claim 10, wherein the bandpass filter comprises at least one adjustable frequency bandpass filter and the bandpass filter is adjusted based on the frequencies of the transmitted signal.

15. An apparatus as claimed in claim 14, comprising a plurality of adjustable frequency bandpass filters.

16. An apparatus as claimed in claim 10, wherein the bandpass filter comprises a bank of fixed frequency bandpass filters and a mechanism to switch between them.

17. An apparatus as claimed in claim 10 wherein the stepped frequency signal is a random step frequency signal.

18. An apparatus as claimed in claim 10 wherein the stepped frequency signal is a linear step frequency signal.

19. An apparatus as claimed in claim 11, wherein the processor generates a digital stepped frequency signal and the transmitter comprises a digital to analogue converter to convert the digital stepped frequency signal to the baseband analogue stepped frequency signal, and wherein the digital mixing signal is derived from the digital stepped frequency signal.
